(19) United States
(12) Patent Application Publication
(10) Pub. No.: US 2015/0074673 A1
(43) Pub. Date: Mar. 12, 2015

(54) CONTROL APPARATUS, CONTROL SYSTEM AND CONTROL METHOD

(71) Applicant: KABUSHIKI KAISHA TOSHIBA, Tokyo (JP)

(72) Inventors: Yuji TOHZAKA, Kawasaki-Shi (JP); Hiroki KUDO, Kawasaki-Shi (JP); Takafumi SAKAMOTO, Tokyo (JP); Noritaka DEGUCHI, Yokohama-Shi (JP)

(73) Assignee: KABUSHIKI KAISHA TOSHIBA, Tokyo (JP)

(21) Appl. No.: 14/203,940

(22) Filed: Mar. 11, 2014

(30) Foreign Application Priority Data
Sep. 12, 2013 (JP) 2013-189257

(51) Int. Cl. G06F 9/46

(52) U.S. Cl. CPC G06F 9/46
USPC 718/103; 718/102

(57) ABSTRACT

According to certain embodiment, there is provided a control apparatus including a processor. The processor controls a first processing unit. The processor acquires determination information for estimating a time delay till execution of a first process is started, in response to receiving an interrupt request for the first process related to the first processing unit from a program being executed underway by the processor or from hardware connected via a bus to the processor, and determines whether to execute the first process or not based on the determination information.

### CROSS-REFERENCE TO RELATED APPLICATIONS

This application is based upon and claims the benefit of priority from Japanese Patent Application No. 2013-189257, filed Sep. 12, 2013; the entire contents of which are incorporated herein by reference.

### FIELD

Embodiments described herein relate to a control apparatus, a control system and a control method.

### BACKGROUND

A conventional control apparatus has a problem of causing a delay in timing for executing a process having a low priority level due to influence of a process having a high priority level. A method of optimally scheduling tasks after grasping execution periods and lengths of execution time of all processes is known as an approach to this problem. This method is based on a premise that the execution periods and the execution time lengths of all the processes can be grasped.

In a communication module capable of implementing a light-weight application, which has spread in recent years, a CPU processes a communication process with a high priority level, while a user is unable to know the execution period and the execution time length thereof. Therefore, the timing for executing the application implemented by the user is delayed due to this influence.

### BRIEF DESCRIPTION OF THE DRAWINGS

FIG. 1 is a block diagram of a control apparatus according to a first embodiment;

FIG. 2 is a flowchart illustrating an operation according to the first embodiment;

FIG. 3 is a block diagram of the control apparatus and a controlled apparatus according to the first embodiment;

FIG. 4 is a flowchart illustrating the operation according to the first embodiment;

FIG. 5 is a flowchart illustrating the operation according to the first embodiment;

FIG. 6 is a flowchart illustrating an operation according to a second embodiment;

FIG. 7 is a block diagram of the control apparatus and the controlled apparatus according to the second embodiment;

FIG. 8 is a sequence diagram illustrating the operation according to the second embodiment;

FIG. 9 is a block diagram illustrating a phase synchronizing system according to a third embodiment;

FIG. 10 is a block diagram illustrating a communication system according to the third embodiment;

FIG. 11 is a functional block diagram related to setting of information used for the operation according to the embodiment of the present invention;

FIG. 12 is an explanatory diagram of a specific example of the operation according to the first embodiment; and

FIG. 13 is a diagram illustrating a countdown timer and a periodic timer.

### DETAILED DESCRIPTION

According to certain embodiment, there is provided a control apparatus including a processor.

The processor controls a first processing unit.

The processor acquires determination information for estimating a time delay till execution of a first process is started, in response to receiving an interrupt request for the first process related to the first processing unit from a program being executed underway by the processor or from hardware connected via a bus to the processor, and determines whether to execute the first process or not based on the determination information.

Embodiments of the present invention will hereinafter be described with reference to the drawings.

### First Embodiment

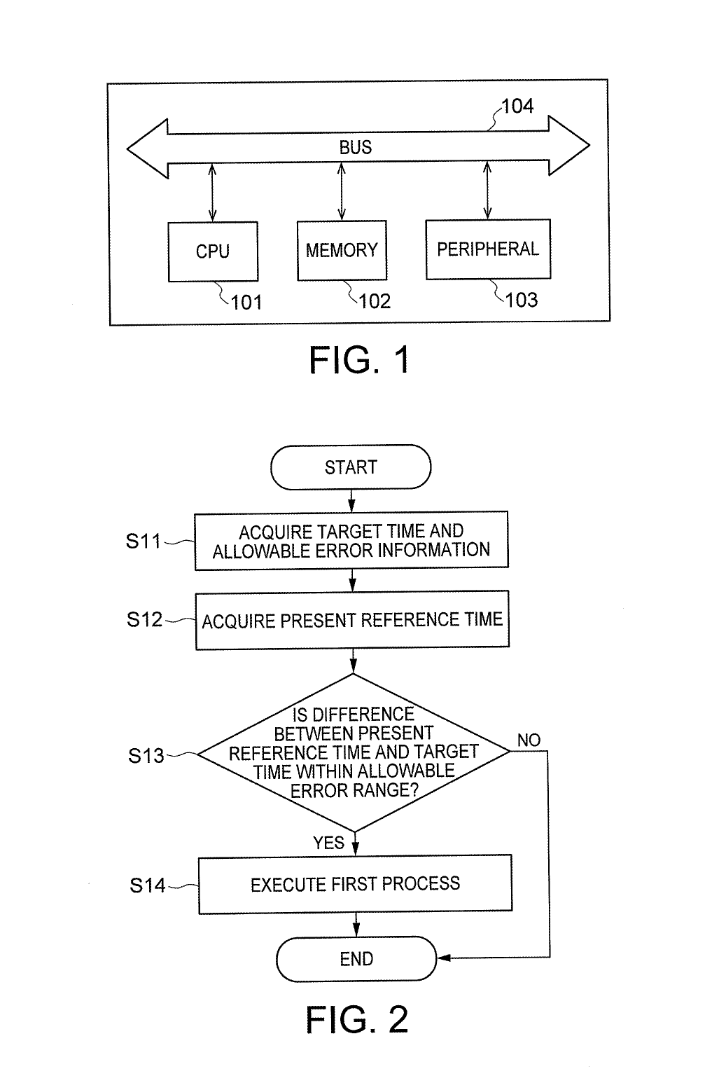

FIG. 1 is a block diagram of a control apparatus according to a first embodiment of the present invention.

In the control apparatus illustrated in FIG. 1, a CPU (Central Processing Unit) 101, a memory 102 and peripheral 103 are connected to a bus 104. The present control apparatus can be implemented as an IC (Integrated Circuit) and an LSI (Large Scale Integration) for general control and communications. Further, the present control apparatus can be implemented as a communication module for a wireless LAN etc. by way of one example.

The CPU 101 reads a program stored in the memory 102 and executes the readout program. The program can be exemplified by a program for executing a communication process, a variety of programs such as user applications and a program for realizing processes of the present embodiment. The CPU 101 is one example of the processor. An MeP (Media embedded Processor), a microprocessor, a micro control unit (MCU) and an MPU (Micro Processing Unit) may be disposed in place of the CPU 101.

The memory 102 includes a ROM (Read Only Memory) classified as a nonvolatile memory and a RAM (Random Access Memory) classified as a volatile memory. It is a widespread practice that the program is written to the ROM, while the data are written to the RAM. With respect to the RAMs, there exist a DRAM (Dynamic RAM) that is generally deemed to have a large storage capacity and an SRAM (Static RAM) that is deemed faster in accessing than the DRAM. It is desirable that the memory 102 includes the SRAM. However, if causing no hindrance to the control, the memory 102 may include the DRAM. The memory 102 gets stored with the program executed by the CPU 101 described above and various items of data needed for the CPU 101 to perform executing.

The peripheral 103 is a functional block existing as a hardware component other than the memory 102. The peripheral 103 corresponds to a first processing unit controlled by the CPU 101. The peripheral 103 is exemplified by a timer that counts a time and generates a trigger of an interrupt process and a PWM (Pulse Width Modulation) that outputs pulse waves. The peripheral 103 is further exemplified, as components for communications, by a USB (Universal Serial Bus), a UART (Universal Asynchronous Receiver Transmitter), a I2C Inter-Integrated Circuit), an SPI (System Pack Interface), a CAN (Control Area Network), an SDIO (Secure Digital Input/Output), a PIO (Parallel Input/Output or Programmed Input/Output), an RTC (Real Time Clock) capable of counting the time independently of the CPU, an ADC (Analog to Digital Converter) that converts an analog signal to a digital signal), a DAC (Digital to Analog Converter) that converts the digital signal to the analog signal, a variety of sensors, communication processing units, and so on. The communication processing unit commonly bears a part of processes on a low-order layer with fastness being required for the digital signal processing.

In the first embodiment of the present invention, the control apparatus includes at least one or more pieces of peripheral. The peripheral becomes a target to be controlled while the CPU 101 processes the software (program). The peripheral 103 includes a calculation unit that calculates determination information for determining, in response to receiving an interrupt request of a first process with respect to the peripheral due to an arbitrary trigger, how long the time delays till execution of the first process is started corresponding to a load state of the CPU 101, and a determining unit that determines based on the determination information whether the first process is executed or not.

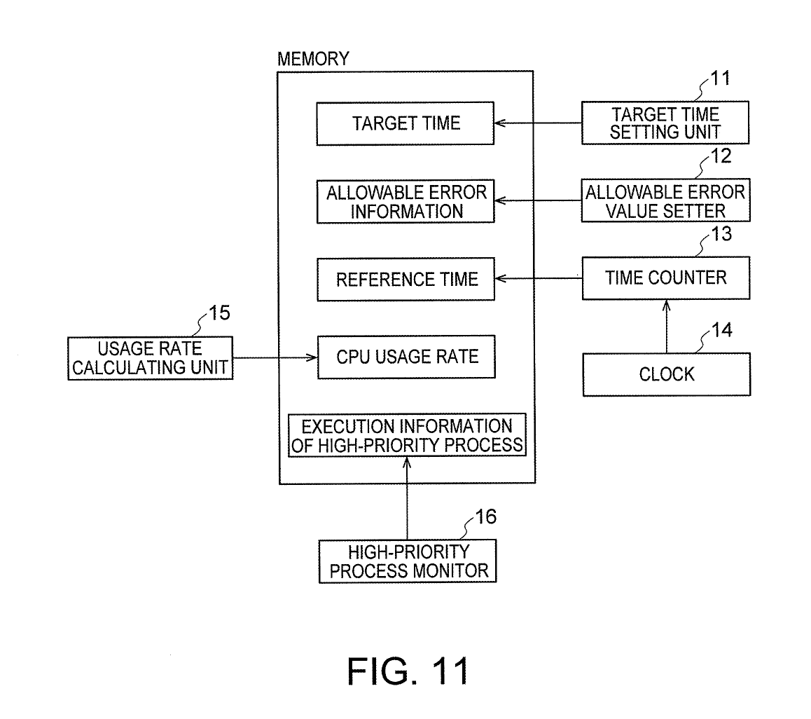

Next, an operation of the control apparatus according to the first embodiment of the present invention will be described by use of FIGS. 1 and 2. FIG. 2 is a flowchart illustrating one example of the operation of the control apparatus according to the first embodiment of the present invention. FIG. 11 is a functional block diagram related to setting of information for use in the operation with respect to the operation according to the first embodiment.

The CPU 101, upon accepting the interrupt request due to the arbitrary trigger, at first acquires target time and allowable error information (see FIG. 11) recorded in the memory 102 in advance of executing the first process (S11).

Herein, the “trigger” indicates an interrupt and occurs hardwarewise or softwarewise. The interrupt process due to a timer that will be described later on may be the trigger. The operation of the present processing flow does not yet start when the interrupt is in a standby status on the CPU 101 but starts when transitioning to an execution status.

The target time is a time targeted for executing the first process. The target time may be uniquely determined beforehand and may also be dynamically calculated and set by a target time setting unit 11 illustrated in FIG. 11 as in the case of output timing control of the pulse waves described later on. For example, if the peripheral includes the PWM, wavelength information (pulse period) of the pulse waves of the PWM is acquired, and the target time may be determined in combination with present reference time (which corresponds to an internal time in the apparatus) obtained in next step S12. The user application may also previously store the target time and the allowable error information in the memory. In a simple configuration, it is considered that the target time and the allowable error information are determined beforehand corresponding to a content of the first process and stored in the memory.

The allowable error information represents a time range (allowable error range) in which to allow the execution of the first process with a deviation from the target time. Namely, the first process is allowed to be executed if being the time within the allowable error range from the target time. The time, if within the allowable error range, corresponds to desired execution time of the first process.

The CPU 101, when acquiring the target time and the allowable error information, acquires next the present reference time (S12). The reference time connotes a time in the control apparatus. The present reference time is, as illustrated in FIG. 11, recorded in a register provided partly in an area of the memory 102. A value of the reference time is incremented and sequentially updated by a time counter 13 defined as any one of a hardware component and software component executed by the CPU 101 in accordance with a clock 14. If being the software component, the time update process is to be executed at a highest priority level. Influence of a CPU processing jitter due to the time update process is to be sufficiently small with respect to the allowable error information for the execution of the first process.

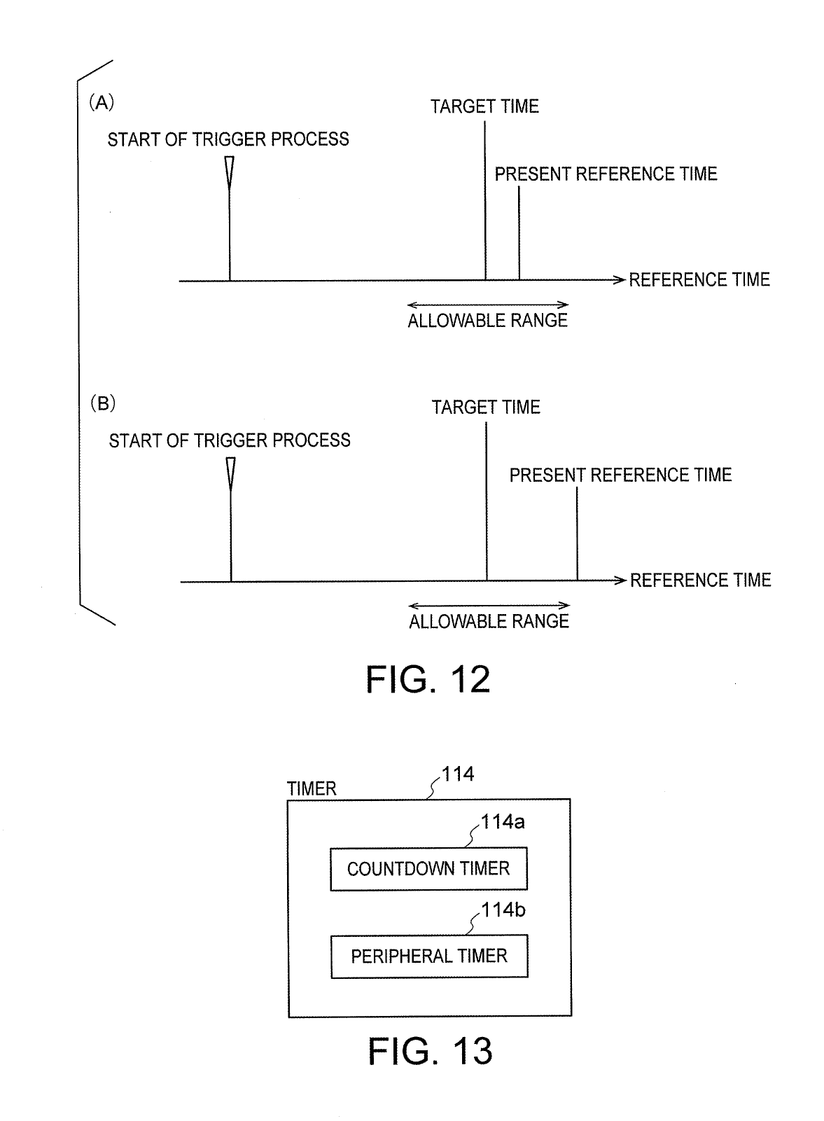

The CPU 101 calculates a difference between the present reference time and the target time and thus acquires this difference as the determination information. Then, the CPU 101 determines whether the difference is within the allowable error range specified by the allowable error information or not (S13). The CPU 101 includes an acquiring unit to acquire the determination information and a determining unit to determine whether a value indicated by the determination information is within the allowable error range or not. If within the allowable error range (YES), the CPU 101 continuously executes the first process (S14), and finishes the processes in the processing flow. FIG. 12(A) specifically illustrates an example in the case where the difference falls within the allowable error range. FIG. 12(A) is a timing diagram, in which the reference time is given along the abscissa axis. In this example, the present reference time is posterior to the target time. However, as far as the difference falls within the allowable error range, the present reference time may be anterior to the target time.

If beyond the allowable error range (NO), the determining unit of the CPU 101 determines not to execute the first process, and terminates the processes of the present processing flow. FIG. 12(B) illustrates a specific example in the case where the difference does not fall within the allowable error range. In this example, the present reference time is posterior to the target time. However, even when anterior to the target time and if not falling within the allowable error range, the first process is not executed. As far as at least the setting can be done, it is desirable that the CPU 101 does not execute other processes till completing the determination as to whether the first process is executed or not since the present reference time has been acquired.

A time length required till acquiring the present reference time since the CPU 101 has accepted the arbitrary trigger depends on the load state or an operating state of the CPU. For example, if the CPU continuously performs the communications with the high priority level even after the occurrence of the trigger, the CPU is in a high-load status, and it is assumed that the time length required till acquiring the present reference time elongates. Further, such a case may arise that the interrupt due to the trigger is made to stand by on account of other processes with the high priority levels, with the result that a transition to the execution status is delayed. Hence, if the CPU is in the high-load status, after the occurrence of the trigger, there increases a possibility that the difference exceeds the allowable error range as a result of determining the difference between the present reference time and the target time. Whereas if the CPU is in a low-load status, it is assumed that the time length expended till acquiring the present reference time since the trigger has occurred is short. Then, such a possibility increases that the difference falls within the allowable error range. If the difference falls within the allowable error range, the CPU immediately executes the first process, thereby enabling the first process to be executed within the allowable error range with respect to the desired timing. Whereas if the difference does not fall within the allowable error range, the first process can be inhibited from being executed at the timing beyond the allowable error range by not executing the first process.

An example of a method of calculating the target time will hereinafter be given by taking, as a specific example, the case where the first process is a process of stopping and starting the pulse waves of the PWM.

As described above, the PWM given by way of one example of the peripheral 103 operates as a dedicated piece of hardware. An assumption is that the CPU 101 previously sets the PWM to operate. In the case of desiring to execute the first process at arbitrary time defined as the target time, the first process can be executed at the target time or within the allowable error range by executing the processing flow in FIG. 2. Then, the pulse waves (e.g., rising or falling of the pulse wave) can be adjusted to the desired reference time.

The target time can be calculated by the following method given by way of one example. If both of a pulse width of the pulse wave and a wavelength of one period are fixed and if having offset information, as expressed in the formula (1), a result of performing a residue calculation of the present reference time with a pulse period can be set as a difference from the target time that is to be switched over to a high level (HIGH) or a low level (LOW) closest to the present reference time. Note that the offset information can be obtained by the same expedient as that of the information on the pulse period described above is obtained. The offset is equal to or larger than “0”. In the case of “0”, any inconvenience may not be caused by not using “0” as the information. The target time can be calculated by adding this difference to the present reference time.

(Difference from Target time)=min {(Present Reference time) % (Pulse Period), (Pulse Period)−((Present Reference time) % (Pulse Period))}+(Offset) Formula (1)

In the formula (1), “A % B” represents a residue given when “A” is a dividend, while “B” is a divisor. It is to be noted that the pulse waves output by the PWM start invariably from “HIGH”, in which case the stop and the start are executed during a LOW-period, thereby making it possible to avoid superimposing high-frequency noises on the pulse waves.

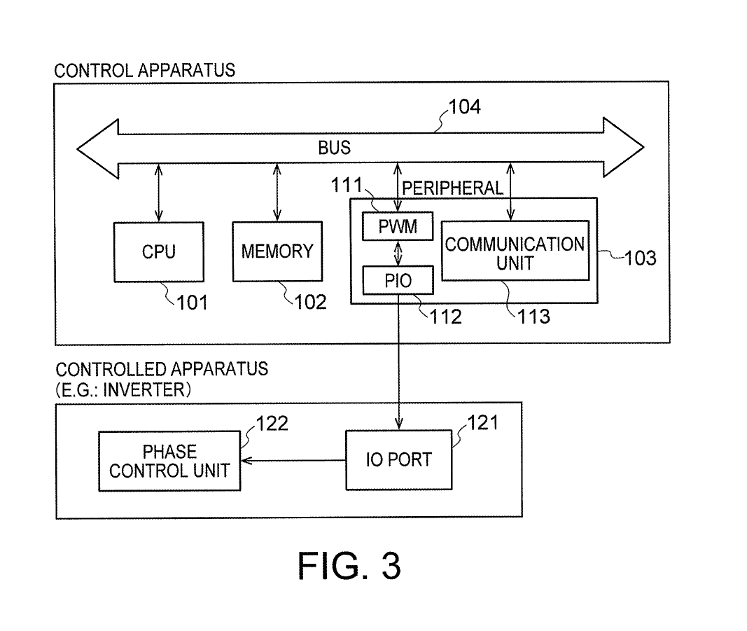

Next, an example of automatically determining the allowable error information corresponding to a controlled target of the control apparatus, will be demonstrated by use of FIG. 3. In FIG. 3, a controlled apparatus is connected to the control apparatus. Herein, an inverter is given by way of an example of the controlled apparatus. The peripheral 103 of the control apparatus includes a PWM 111, a PIO 112 and a communication unit 113. The controlled apparatus includes an IO port 121 and a phase control unit 122.

The PIO 112 outputs the pulse wave as a timing reference signal to the inverter in a way that corresponds to an output of the pulse wave generated by the PWM 111.

The inverter receives this timing reference signal via an IO (Input/Output) port 121 or another interface. The phase control unit 122 controls a phase of an AC output on the basis of the pulse wave inputted from the IO port 121.

In the case of adjusting the phase of the AC output of the inverter to the desired reference time of the control apparatus, a value of the allowable error is determined based on a predetermined ratio with respect to the wavelength of one period of the AC output.

For example, if the value of the allowable error is determined to be 5% of the wavelength, the allowable error becomes 1 millisecond at 50 Hz and 500 microseconds at 100 Hz. The setting of the value of the allowable error is realized by way of one example such that an allowable error value setter 12 illustrated in FIG. 11 acquires frequency information of the inverter and updates a value of the register of the memory 102 on which the allowable error information is recorded. The allowable error value setter 12 may acquire the frequency information from the inverter defined as the controlled apparatus via the communication unit 113 and may also acquire the frequency information from another control apparatus wiredly or wirelessly. The allowable error value setter 12 is a functional block realized by hardware or software executed on the CPU 101. In the case of the hardware, this hardware may be a part of the peripheral 103 and may also be another circuit connected to the bus 104 separately therefrom.

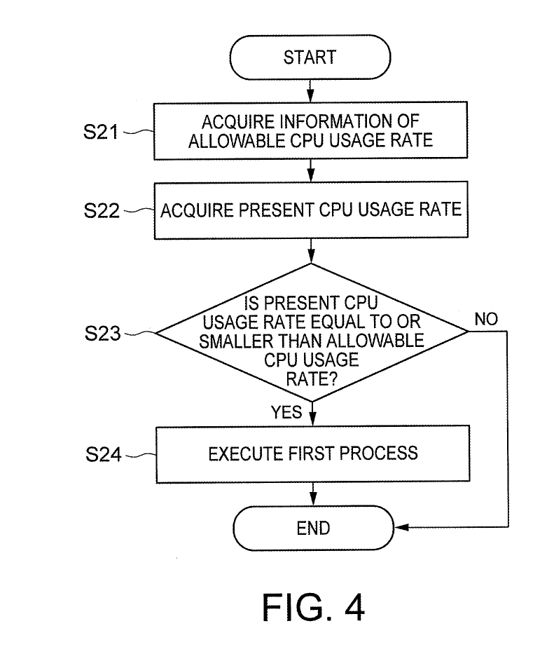

FIG. 4 is a flowchart illustrating another example of the operation of the control apparatus according to the first embodiment of the present invention.

The control apparatus has, as illustrated in FIG. 11, a usage rate calculating unit 15 that calculates a CPU usage rate. An operation scheme of the present processing flow is to determine, based on this usage rate calculating unit 15, whether the first process can be executed or not. The CPU usage rate indicates a rate at which the program being executed underway occupies the processing time of the CPU. To give one example, it is considered that the CPU usage rate is measured by using an RTC (Real Time Clock) as the peripheral via the I2C. The CPU usage rate may be periodically calculated and written to the memory and may also be calculated when the CPU 101 accepts the interrupt due to the arbitrary trigger.

The CPU 101, when accepting the interrupt due to the arbitrary trigger, acquires the allowable error information (e.g., an allowable CPU usage rate) recorded on the memory 102 in advance of executing the first process (S21).

Next, the CPU 101 reads the present CPU usage rate from the register of the memory and thus acquires the usage rate as the determination information (S22). The CPU usage rate may also be acquired directly from the CPU usage rate measurer.

If the present CPU usage rate is within the allowable error range, e.g., if equal to or smaller than the allowable CPU usage rate (YES), the CPU 101 continuously executes the first process (S24) and finishes the present processing flow. Whereas if beyond the allowable error range, e.g., if larger than the allowable CPU usage rate (NO), the CPU 101 finishes the processes in the present processing flow without executing the first process.

Thus, it can be expected that the first process is executed within the desired timing range by executing the first process only when the CPU usage rate is within the allowable error range.

The case of measuring the CPU usage rate by utilizing the RTC is given in the example described above, and a method of estimating and thus acquiring the CPU usage rate will be given as below. To give one example, if a high-priority process (exhibiting a higher priority level than the first process) executed by the CPU is a communication process, the CPU usage rate can be estimated from a traffic thereof. For example, a traffic measuring unit, which counts a transmission/reception packet count for a fixed time interval, is provided as a CPU usage rate calculator. The traffic measuring unit is a functional block realized by hardware or software executed on the CPU 101. A relationship between the transmission/reception packet count and the CPU usage rate is transformed into a function or tabularlized beforehand. The traffic measuring unit calculates the transmission/reception packet count per fixed time interval and writes the calculated packet count to the predetermined register within the memory, thereby updating the value of the register. The CPU obtains the CPU usage rate corresponding to the transmission/reception packet count acquired from the register on the basis of the function or the table.

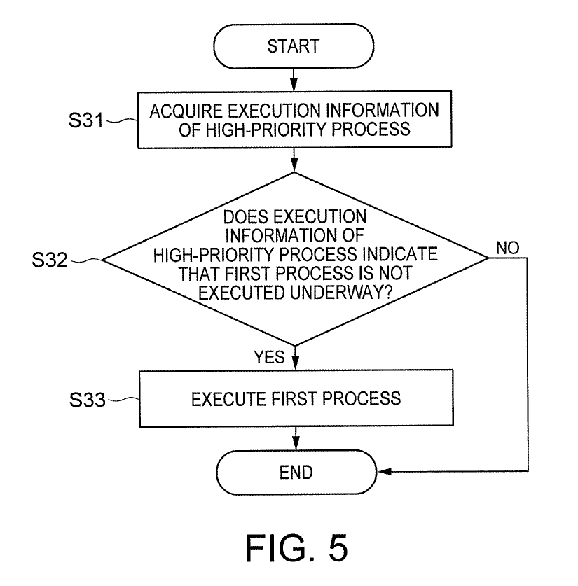

FIG. 5 is a flowchart illustrating still another example of the operation of the control apparatus according to the first embodiment of the present invention. In the processes of this processing flow, when accepting an interrupt due to the trigger (when the interrupt due to the trigger transitions to the execution status from the standby status), the CPU executes the high-priority process having the higher priority level than the first process, in which case the execution of the first process is not done. Whereas if not so, the first process is executed.

The CPU 101 acquires, with the arbitrary trigger, high-priority process execution information as the determination information in advance of executing the first process (S31). The high-priority process execution information is information for indicating whether the high-priority process is executed underway or not. If this information indicates that the high-priority process is not executed underway (YES), the CPU 101 executes the first process (S33) and terminates the processes in the present processing flow. Whereas if indicating that the high-priority process is executed underway (NO), the CPU 101 finishes the processes in the present processing flow without executing the first process.

Herein, a method of setting the high-priority process execution information will be described. The high-priority process execution information takes a flag format and is stored in the register having an area of 1 or more bits that is provided in the memory. For instance, the high-priority process is the communication process, in which case a flag is set (ON) when starting the communications but is cancelled (OFF) when finishing the communication process. It is therefore feasible to determine by referring to the flag of the register whether the communication process is executed underway or not. A high-priority process monitor 16 depicted in FIG. 11 sets the high-priority process execution information and is realized as a functional block of the hardware or the software executed by the CPU.

A processing state of the CPU changes from time to time, and it is therefore desirable to acquire the CPU usage rate and information equivalent thereto (S21 etc. in FIG. 4) and to acquire the high-priority process execution information (S31 etc. in FIG. 5) before executing the first process. Moreover, the CPU usage rate and the information equivalent thereto are schemed to be periodically calculated. Then, a latest value thereof is used when determining whether the first process can be executed or not. Alternatively, there may be employed an average value (a simple average, a moving average, etc.) using the values in the past and statistics such as a median, a mode, a maximum value, etc. of the values for X-number of times in the past.

Further, a period for measuring the CPU usage rate one time needs to be short enough to detect the execution state of the high-priority process. To give one example, the high-priority process is the communication process, in which case the measuring period is desirably on the order of nanosecond to microsecond, though depending on the operating frequency of the CPU.

Moreover, such a possibility exists that the CPU usage rate rises due to the execution of the process having the same or lower priority level as or than the priority level of the first process. As for the process such as this, the usage rate of the CPU executing underway is individually measured and stored on a process-by-process basis beforehand. Alternatively, a flag is set, which indicates that the process having the same or lower priority level is executed underway. Then, the flag is referred to when acquiring the CPU usage rate, and a value obtained by subtracting the CPU usage rate in the process having the same or lower priority level from the present CPU usage rate may be used as an effective CPU usage rate (determination information). The thus-calculated effective CPU usage rate represents the CPU usage rate based on the execution of the process having the high priority level.

As discussed above, according to the first embodiment of the present invention, a difference between the present reference time and the target time is checked immediately before executing the first process. If the difference is within the allowable error range, the target process (the first process) is executed. The first process can be thereby executed in a way that accurately adjusts the first process to the target time or within the allowable error range while taking into the consideration the influence of the CPU processing jitter affecting the first process. The accuracy of the execution time with respect to the target time can be improved in exchange of a probability that the target process will be executed, by setting the allowable range. If beyond the allowable error range, the target process is not executed. Hence, this is particularly effective in the case of an instruction given to the hardware such as the PWM with the first process working independently.

Further, in accordance with the CPU usage rate or the information equivalent thereto, if the CPU usage rate exceeds an allowable value, the first process is not executed. The execution timing of the first process can be thereby stabilized. Moreover, in the case of executing the high-priority process also, the execution timing of the first process can be stabilized by not executing the first process.

Thus, according to the first embodiment, it is feasible to reduce the delay of the execution timing due to the influence of the CPU processing jitter. Especially, the first embodiment is effective in a case where the process having the high priority level is blackboxed and thus executed in the CPU.

### Second Embodiment

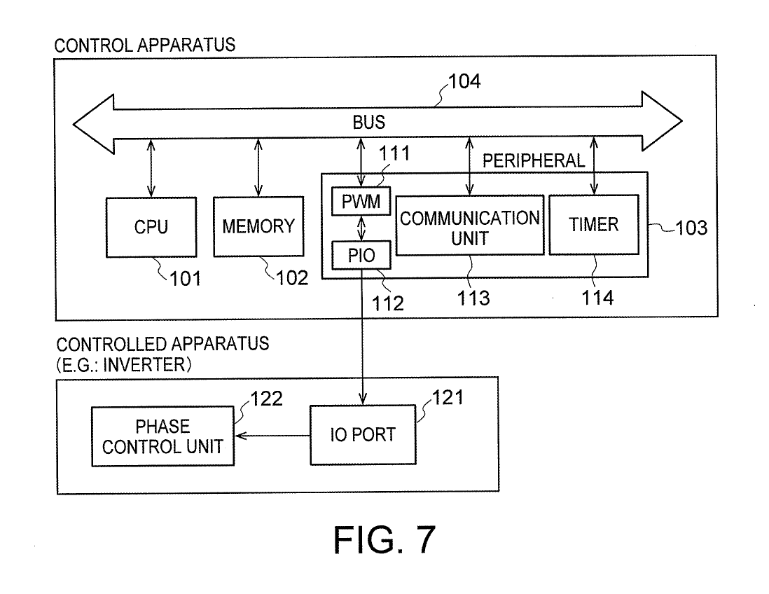

A countdown timer is used for getting the trigger of the first process to occur, thereby enabling a reduction of a difference between the target time and the time for executing the first process. The countdown timer can be realized as hardware (see FIG. 7 given later on) or software running on the CPU by way of one example. The countdown timer, when the set-up time elapses, causes the interrupt to occur in the CPU 101.

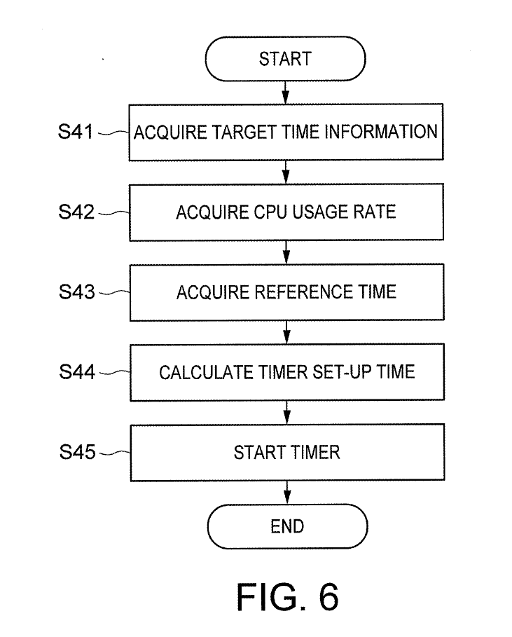

FIG. 6 illustrates how the timer sets up the time and a starting procedure thereof in the second embodiment of the present invention.

To begin with, the CPU 101, upon accepting the arbitrary trigger, acquires the target time recorded in the memory 102. However, as the output timing adjustment of the pulse wave has been exemplified above, the target time may not be uniquely determined. The target time may be dynamically determined such as determining the target time from the present reference time and the pulse period (S41).

Next, the CPU 101 acquires the CPU usage rate from the memory (S42) and the present reference time from the memory (S43). The acquisition of the CPU usage rate and the acquisition of the present reference time may be exchanged in terms of a sequential order. In the case of acquiring the present reference time on ahead, the time length required for acquiring the CPU usage rate is previously measured. Then, the present reference time acquired on ahead may be corrected based on this measured time length.

The CPU 101 calculates a time value to be set up in the countdown timer from the acquired present reference time, and sets up the calculated time value in the countdown timer (S44). The time value to be set up is, as one example, a value obtained by subtracting an adjustment quantity corresponding to the CPU usage rate from the difference between the acquired present reference time and the target time.

The adjustment quantity can be acquired as follows. A relationship between the CPU usage rate and the CPU processing jitter is previously measured, and a relationship between the adjustment quantity and the CPU usage rate is transformed into a function or tabularlized. The CPU usage rate acquired in step S42 is converted into the adjustment quantity by use of the function or the table. With this conversion, the adjustment quantity corresponding to the CPU usage rate can be obtained.

The CPU 101, after setting up the thus-calculated time in the countdown timer, starts the countdown timer (S45). The countdown timer, when the set-up time elapses, causes the interrupt to occur in the CPU 101. The CPU 101 processes the trigger (interrupt) according to, e.g., the priority level, and executes the first process.

The output timing adjusting method of the pulse wave will hereinafter be described as a specific example of a control method using the countdown timer. FIG. 7 is given as a diagram for explaining this specific example, which illustrates the control apparatus according to the second embodiment. A timer 114 is added to the peripheral of the control apparatus illustrated in FIG. 3.

The timer 114 includes, as illustrated in FIG. 13, in addition to the countdown timer 114a described above, a periodic timer 114b for periodically adjusting the output timing of the pulse wave. A periodic trigger occurs periodically from the periodic timer 114b. The CPU, upon receiving the periodic trigger (periodic interrupt), calculates a timer value to be set up in the countdown timer, and sets up the calculated timer value in the countdown timer, thereby starting the countdown timer. When the countdown timer is timed out, the trigger occurs in the CPU from the countdown timer. Then, the CPU, upon receiving the trigger, executes the first process. However, the method of setting and starting the countdown timer is not limited to the method using the periodic timer such as this.

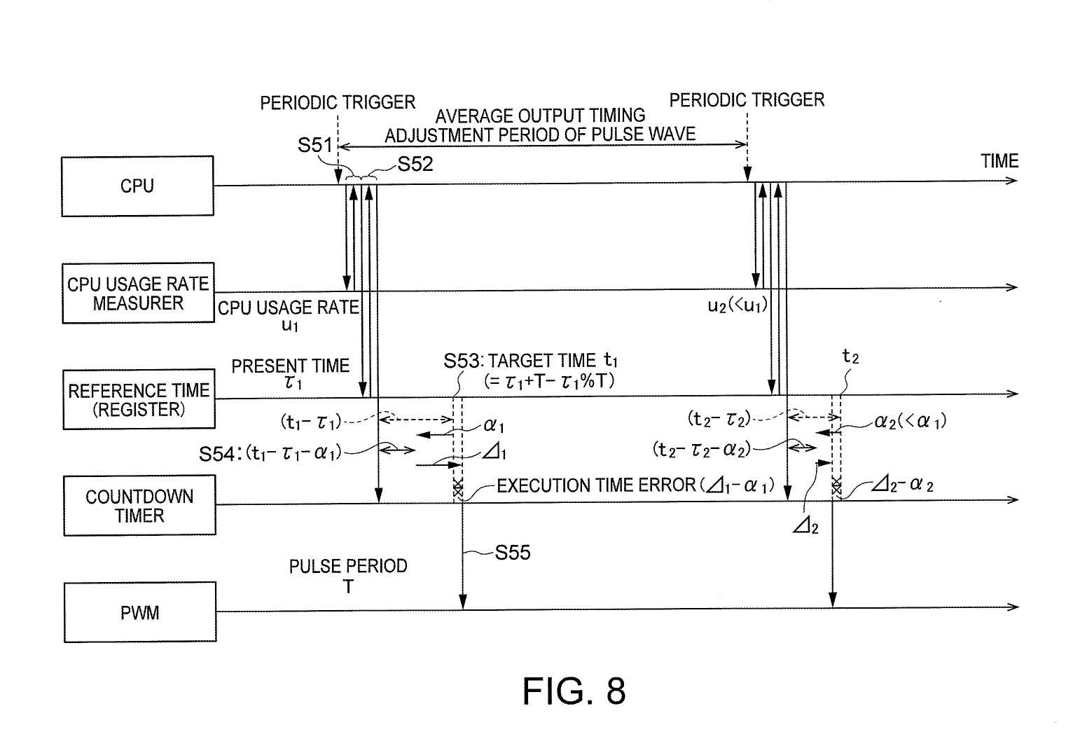

FIG. 8 depicts an operation sequence of the control apparatus according to the second embodiment. Behaviors of the respective functional blocks are illustrated as sequences. A solid line with an arrow extending vertically (herein, each solid line extends to the PWM) indicates timing of the control executed by the CPU 101 up till the first process is executed.

The CPU 101 acquires pulse periodic information T (omitted in FIG. 8) as a substitute for the target time information illustrated in FIG. 6 due to the periodic trigger give from the periodic timer. Then, the CPU 101 acquires a CPU usage rate u₁ (S51) and further present reference time T₁ (S52). In this example, the CPU usage rate is acquired directly from the CPU usage rate measurer. However, a configuration for acquiring the CPU usage rate from the memory is also available.

The target time is calculated in, e.g., a formula (2) (S53). Note that FIG. 8 illustrates an example of the offset being “0”.

(Target time t₁)=(Present Reference time T₁)+(Pulse Period T)−((Present Reference time T₁)%(Pulse Period T))+(Offset δ) Formula (2)

A value of the set-up time of the countdown timer is calculated in, e.g., a formula (3) (S54).

(Timer Set-up time)=(Target time t₁)−(Present Reference time T₁)−(Timer Adjustment Quantity α₁) Formula (3)

The timer adjustment quantity α₁ can be, as described above, obtained by converting the CPU usage rate u₁ on the basis of the function or the table etc.

The time value is set up in the countdown timer, and the timer is started. Then, after an elapse of (t₁−T₁−α₁), the countdown timer is timed out, whereby the trigger occurs. In the example of FIG. 8, the CPU 101 starts processing after an elapse of Δ₁ since the trigger has occurred from the countdown timer (S55), in which the timing is delayed by a CPU processing jitter (Δ₁−α₁) from the target time t₁. Namely, the output of the pulse wave is stopped and started as the first process with an error (Δ₁−α₁) on the basis of the target time t₁. When the CPU 101 executes the process having the high priority level, the interrupt (the interrupt of the countdown timer) of the first process having the lower priority level than the former process is kept on standby, the start of executing the interrupt is delayed, and the interrupt process itself is delayed as the case may. Note that the arrowed line extends to the PWM directly from the countdown timer in FIG. 8, which implies that the trigger given from the countdown timer is processed by the CPU 101, and the PWM is controlled as the execution of the first process from the CPU 101.

A sequence with respect to the second execution of the first process is illustrated on the right side in FIG. 8. In this example, a CPU usage rate u₂ is smaller than the CPU usage rate u₁ in the first sequence. Correspondingly, it is also shown that a timer adjustment quantity α₂ is smaller than the timer adjustment quantity α₁. Further, the first process is carried out earlier by |Δ₂−α₂| than the target time t₂.

Note that a delay of each calculation process (the calculation process of the target time, the calculation process of the timer set-up time, etc.) is previously measured or obtained from a required clock count, and the timer set-up time may be corrected based on this delay.

It is to be noted that the measurement of the CPU usage rate may be done periodically as described above and may also involve using the statistic of the values acquired once or more times in the past as the effective (execution) CPU usage rate. The statistic is exemplified by the average value (the simple average, the moving average, etc.), the median, the mode, the maximum value, etc. of the values for X-number of times in the past. The influence of the CPU processing jitter can be estimated more accurately as a frequency of acquiring the CPU usage rate becomes higher. However, the excessive acquisition of the CPU usage rate has a possibility of its becoming a factor for increasing the CPU usage rate. Such being the case, a relationship between the acquisition frequency of the CPU usage rate and the estimation accuracy of the CPU processing jitter is clarified by the measurement, and the acquisition frequency of the CPU usage rate satisfying the required estimation accuracy may also be set.

Moreover, such a possibility exists that the CPU usage rate increases due to the process, of which the priority level is the same as or equal to or lower than the priority level of the first process. As for the process such as this, the usage rate of the CPU executing underway is, as described above, individually measured and stored beforehand. The flag is set, which indicates that the process, of which the priority level is the same as or equal to or lower than the priority level of the first process, is executed underway. Then, the flag is referred to when acquiring the CPU usage rate during the actual operation, and a value obtained by subtracting the CPU usage rate in the relevant process may be used as the effective CPU usage rate.

Note that if the CPU usage rate cannot be acquired during the operation, the relationship between the CPU usage rate and the CPU processing jitter is measured on ahead, and a fixed timer adjustment quantity may be set to minimize the influence of the CPU processing jitter even by obtaining whatever CPU usage rate. The average value of the CPU processing jitters in the case of the minimum CPU usage rate and in the case of the maximum CPU usage rate is adopted as one example, thereby obtaining a fixed level of effect in reducing the maximum error with respect to the target time of the execution time of the first process.

As discussed so far, the control apparatus according to the second embodiment enables the influence of the CPU processing jitter to be corrected by predicting a degree of the CPU processing jitter affecting the target process. The control apparatus also enables, if the degree of the CPU processing jitter exceeds the allowable value, the execution timing of the target process to be stabilized by not executing the target process.

Furthermore, together with checking the time immediately before executing the first process described in the first embodiment, it is feasible to improve the possibility of executing the first process at the time close to the target time by using the countdown timer for the trigger. However, the timing of the first process is affected by the CPU processing jitter due to the execution of the high-priority process. This being the case, the influence of the CPU processing jitter affecting the first process can be relaxed by predicting the degree of the CPU processing jitter and reflecting the predicted degree in the setting of the countdown timer.

Moreover, in the case of executing another process of which the execution priority level is the same as or equal to or lower than the priority level of the first process, the first process is not necessarily influenced by the CPU processing jitter to a degree proportional to the CPU usage rate. Thereupon, the CPU usage rate of another process with its execution priority level being the same as or equal to or lower than the priority level of the first process is individually measured on ahead. Then, this CPU usage rate is subtracted from the present CPU usage rate corresponding to the execution state, thereby calculating the effective CPU usage rate and enabling the influence of the CPU processing jitter to be relaxed at the high accuracy.

Note that even when the CPU usage rate cannot be measured during the operation, a proper fixed value of the timer adjustment quantity is set up beforehand, thereby obtaining the fixed level of effect in relaxing the influence on the CPU usage rate.

### Third Embodiment

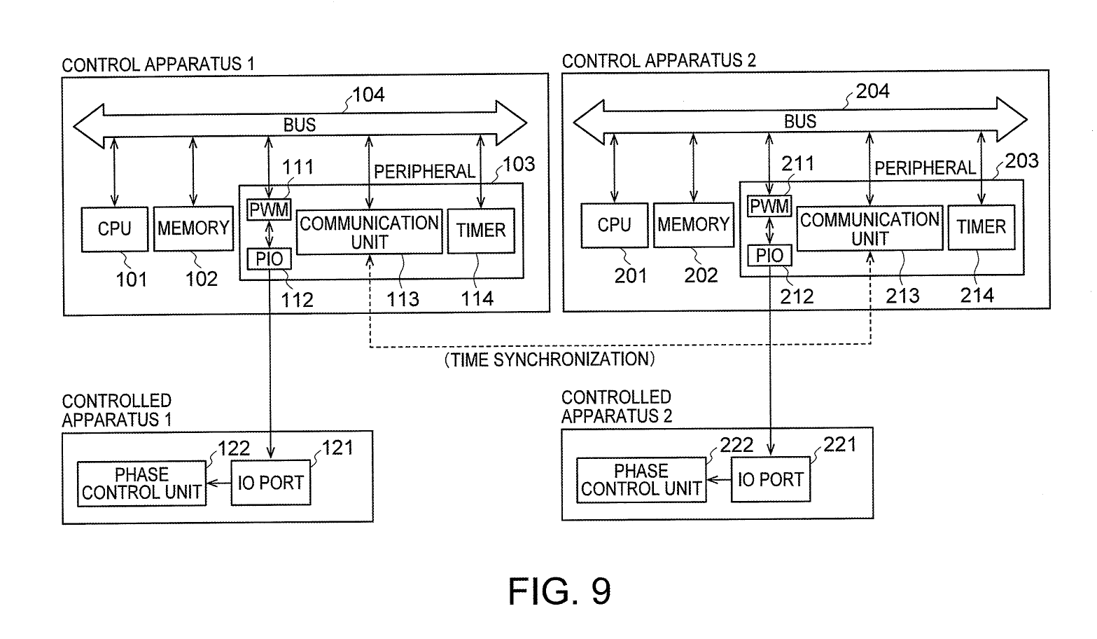

FIG. 9 depicts an example of a phase control system as a control system according to a third embodiment of the present invention. This control system includes two pairs of control apparatuses and controlled apparatuses explained in the first embodiment of the present invention. To be specific, there are provided a pair of a control apparatus 1 and a controlled apparatus 1 and a pair of a control apparatus 2 and a controlled apparatus 2. The illustrated example shows the two pairs of control apparatuses and the controlled apparatuses. However, two or more pairs of these control and controlled apparatuses may also be provided.

The control apparatus 1 and the controlled apparatus 1 are the same as the control apparatus and the controlled apparatus illustrated in FIG. 7, and hence the repetitive explanations thereof are omitted except extended or modified processes. The control apparatus 2 and the controlled apparatus 2 are the same as the control apparatus and the controlled apparatus illustrated in FIG. 7. Therefore, the block numerals of 201-204, 211-214, 221-222 are reallocated and thus displayed, and the repetitive explanations thereof are omitted except extended or modified processes.

In this system, the respective control apparatuses are time-synchronized via communication units 113, 213 of the control apparatuses, thus synchronously controlling the respective controlled apparatuses. An implication that the respective control apparatuses are time-synchronized is to synchronize the reference time of one control apparatus with the reference time of another control apparatus. In the illustrated example, the outputs of the pulse waves of the PWMs 111, 211 are synchronized by synchronizing the times of the respective control apparatuses, thereby synchronously controlling the individual controlled apparatuses. For example, the controlled apparatuses, if being the inverters, output AC power in a way that adjusts the phases to the pulse waves inputted from the PIOs 112, 212 of the respective control apparatuses, thereby synthesizing the AC outputs of the plurality of inverters at a high power factor. This scheme is effective particularly in an inverter system independent of a system serving as the reference for synchronizing the AC power outputs. For instance, the time synchronization is carried out while making the target time in the first or second embodiment coincident between the respective control apparatuses. The phase of the individual controlled apparatuses can be thereby synchronized.

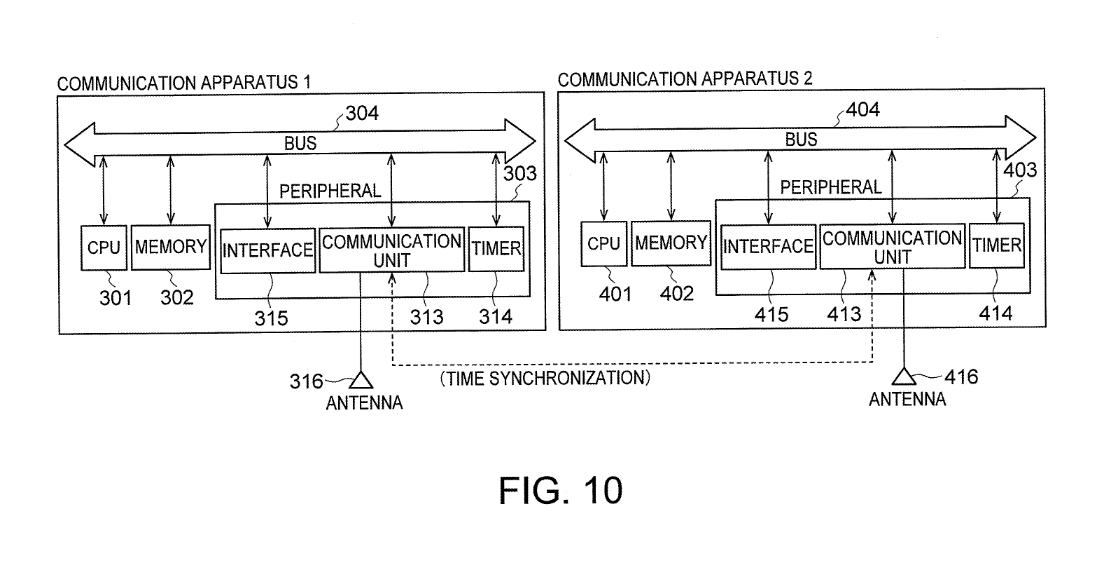

FIG. 10 illustrates a wireless sensor network system as a control system according to the third embodiment of the present invention.

This system includes a communication apparatus 1 and a communication apparatus 2 as the two control apparatuses. However, the present system may be configured to include three or more communication apparatuses. In the present system, each communication apparatus starts up a communication unit only when a necessity arises, and performs sleep control for transmitting and receiving the data.

In the communication apparatus 1, a CPU 301, a memory 302 and peripheral 303 are connected to a bus 304. The peripheral 303 includes a communication unit 313, a timer 314, an interface 315 and an antenna 316. Similarly, in the communication apparatus 2, a CPU 401, a memory 402 and peripheral 403 are connected to a bus 404. The peripheral 403 includes a communication unit 413, a timer 414, an interface 415 and an antenna 416. The operations of the blocks having the same nomenclatures as those of the control apparatuses described so far are basically the same, and hence the repetitive explanations thereof are omitted except extended or modified processes. The interfaces 315, 415 are interfaces with the external devices and acquire analog or digital data wiredly or wirelessly from the external devices. For example, sensing data are acquired from a sensor attached to a living body.

Herein, similarly to the inverter system illustrated in FIG. 9, the time synchronization is carried out through the communications (herein, the wireless communications in particular) between the communication units 313 and 413. When reaching the predetermined time, the communication units 313, 413 are started up for transmitting and receiving the data. Then, upon finishing the transmission and the reception, power consumption is restrained by executing the control to stop a power supply of each of the communication units 313, 413 or the control to shift to a low power consumption mode.

In the case of the present system, even when keeping a fixed level of accuracy of the synchronization of the reference times held by the respective communication apparatuses, a control delay occurs on the occasion of controlling the communication units 313, 413. This control delay leads to a possibility of failing to perform the communications if the startup does not keep up with the transmission/reception time of another communication apparatus due to this delay. In this case, the power consumed during the startup in the meantime results in futility. Further, if executing an instruction to start up the communication apparatus at an early time as a measure against the failure in communications, an effect in reducing the power consumption decreases.

Such being the case, according to the third embodiment, the time for performing the communications by the startup process is set as the target time, the first process is set as the communication process. Then, the communication unit is started up at the proper timing and executes transmitting or receiving the data. If there can be a delay equal to or longer than a predetermined time length with respect to the target time, a scheme is that the communication unit is not started up. This scheme enables the power consumption to be reduced effectively. Note that if the communication unit is not started up on account of the delay, the data may be transmitted and received on the next occasion. The control being thus conducted, it is possible to inhibit the communication unit of at least one communication apparatus from being started up with the futility, whereby the effect in reducing the power consumption can be enhanced.

The communication between the communication units 313 and 413 may take any type of system if equipped with the synchronizing mechanism, and it does not matter whether the communication is performed wiredly or wirelessly. It does not matter whichever system is taken for the synchronization. However, the system is required to attain the synchronization accuracy sufficient for controlling the synchronization between the controlled apparatuses. As for the communication system and the synchronization system, e.g., it is known that the accuracy as high as several milliseconds is acquired in bidirectional wired communications based on NTP (Network Time Protocol). Further, the accuracy as high as several microseconds is acquired in unidirectional communications in which time information contained in a beacon frame is distributed based on TSF (time synchronization Function) according to IEEE802.11 known as the wireless LAN. When the inverters are assumed to be the controlled apparatuses, the synchronization accuracy of the wireless LAN is sufficient for synchronizing 50 Hz AC output phases between the inverters.

The control apparatus in each embodiment may also be realized using a general-purpose computer device as basic hardware. In this case, the control apparatus may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A control apparatus comprising:
a processor configured to control a first processing unit,
wherein the processor acquires determination information for estimating a time delay till execution of a first process is started, in response to receiving an interrupt request for the first process related to the first processing unit from a program being executed underway by the processor or from hardware connected via a bus to the processor, and determines whether to execute the first process or not based on the determination information.

2. The control apparatus according to claim 1, wherein the processor executes the first process in a case that the processor has determined to execute the first process.

3. The control apparatus according to claim 1, further comprising a time counter configured to count a time as a reference time,
wherein the processor acquires the reference time indicated by the time counter, in response to receiving the interrupt request, and calculates the determination information based on a difference between the reference time and a target time for executing the first process.

4. The control apparatus according to claim 3, wherein the determination information represents a difference between the target time and the reference time, and
the processor determines to execute the first process if the difference falls within an allowable range, and determines not to execute the first process whereas if not within the allowable range.

5. The control apparatus according to claim 4, further comprising a setting unit configured to set up the allowable range,
wherein the first processing unit controls an inverter that outputs AC power, and
the setting unit sets up the allowable range based on information on a frequency of the AC power output by the inverter.

6. The control apparatus according to claim 1, further comprising a usage rate calculating unit configured to calculate a usage rate of the processor or a statistic of the usage rates,
wherein the processor acquires the processor usage rate calculated by the usage rate calculating unit or the statistic of the usage rates as the determination information, in response to receiving the interrupt request, and determines based on the determination information not to execute the first process if the processor is in a high load status and determines to execute the first process if not in the high load status.

7. The control apparatus according to claim 6, wherein the processor determines that the processor is in the high load status if the usage rate or the statistic is equal to or larger than an allowable value.

8. The control apparatus according to claim 1, further comprising:
a timer; and
a usage rate calculating unit configured to calculate a usage rate of the processor or the statistic of the usage rates,
wherein instead of determining whether to execute the first process, the processor acquires the usage rate or the statistic of the usage rates as the determination information, sets up a time in the timer based on the target time for executing the first process and the determination information, and executes the first process according to an interrupt issued from the timer when the timer is timed out.

9. The control apparatus according to claim 8, wherein the processor sets up, in the timer, the time that becomes smaller as the usage rate becomes higher.

10. The control apparatus according to claim 6, wherein the usage rate calculating unit calculates an individual usage rate or a statistic of the individual usage rates per each of processes executed by the processor, and
the processor acquires a value obtained by subtracting the individual usage rate of a predetermined one of the processes or a statistic of the individual usage rates from the usage rate of the processor or the statistic of the usage rates of the processor, as the determination information.

11. The control apparatus according to claim 1, further comprising a memory configured to store information indicating whether or not a second process having a higher priority than that of the first process is executed underway,
wherein the processor acquires the information in the memory as the determination information and determines to execute the first process if the information indicates that the second process is not executed underway.

12. The control apparatus according to claim 3, further comprising a memory configured to store the reference time,
wherein the time counter counts up the reference time in the memory to sequentially update the reference time, and
the processor acquires the reference time by reading from the memory.

13. The control apparatus according to claim 3, further comprising a memory configured to store the target time,
wherein the processor acquires the target time by reading from the memory.

14. The control apparatus according to claim 6, further comprising a memory,
wherein the usage rate calculating unit writes the calculated usage rate of the processor or the calculated statistic of the usage rates to the memory, and
the processor acquires the usage rate or the statistic of the usage rates by reading from the memory.

15. A control system comprising:
first and second control apparatuses each according to claim 1,
wherein the first control apparatus includes a first communication unit configured to perform communication with the second control apparatus,
the second control apparatus includes a second communication unit configured to perform the communication with the first control apparatus, and
the first and second control apparatuses synchronize respective reference times by use of the first and second communication units, the reference times being internal times in the first and second control apparatuses.

16. The control system according to claim 15, wherein each of the first and second control apparatuses includes: a memory configured to store the reference time; and a time update unit configured to update the reference time by counting up the reference time in the memory,
the processor calculates the determination information based on a difference between the target time for executing the first process and the reference time in the memory, and
the target time of the first control apparatus is same as the target time of the second control apparatus.

17. A control method comprising:
acquiring, by a processor controlling a first processing unit, determination information for estimating a time delay till execution of a first process is started, in response to receiving an interrupt request for the first process related to the first processing unit from a program being executed underway by the processor or from hardware connected via a bus to the processor, and
determining whether to execute the first process or not based on the determination information.
